(19) United States
(12) Patent Application Publication
(10) Pub. No.: US 2009/0235087 A1
(43) Pub. Date: Sep. 17, 2009

(54) Security for Computer Software

(76) Inventor: Geoffrey David Bird, Auckland (NZ)

Correspondence Address: Caryn DeHoratius;BALDWINS, Level 14, 342 Lambton Quay, Wellington, 6011, NZ

(21) Appl. No.: 11/570,561

(22) PCT Filed: Jun. 24, 2005
(86) PCT No.: PCT/NZ05/00141

§ 371 Date: Aug. 23, 2007

(30) Foreign Application Priority Data
Jun. 24, 2004 (NZ) 533756

(51) Int. Cl. G06F 11/30; G06F 12/14

(52) U.S. Cl. 713/190; 726/2

(57) ABSTRACT

Persistent protection for application-specific or dependent software such as a workbook for use with independent software (such as Excel™) includes encryption of at least some instructions or other key information before distribution hence providing intellectual property security and (optionally) location security. The cooperative decoder module provides means for secure and controlled decryption of the secured content, if the cooperative security module has confirmed an authorised environment. The invention provides persistent security such that the secured content remains encrypted and is barred from access such as by a hacker, so cannot feasibly be amended or published.

### FIELD

This invention relates to computer security arrangements for software, particularly arrangements employing software routines to provide persistent security which have the effect of blocking unauthorised access to instructions or data. More particularly this invention relates to security measures for protecting “dependent software” as herein defined.

### DEFINITIONS

Note: Use of the male gender herein should be taken to encompass all genders. All commercial products referred to herein should be assumed to be Trade Marks, whether registered or not. For example, Excel (see below) is a distinctive trade mark for a spreadsheet.

AUTHORISATION MODULE or PROGRAM refers to the module or program which serves to check for a current authorised environment and which enables the decoder module if one is found.

AUTHORISED ENVIRONMENT is used herein to such as a single computer, a computing environment, a business entity, or a particular network which has been granted permission for operation of secured software. Examples of factors which may qualify an environment as authorised include one or more of: receipt of payment for one-time use, presence of a pre-identified environment (whether based on local PC hardware or perhaps software identification, network system details and/or authentication), etc, or presence of an authenticated version of the host software package. The last condition would apply if the owner or licensor of a software package wanted to distribute dependent software yet restrict its use to legitimate owners.

AUTHORISED USER is used herein to refer to a person who has been granted permission to operate secured software. Factors which may qualify a person as authorised include: entry of a password, public key, private key, or other data sequence. This person may have a key usable within a deciphering file. Other conditions may apply, such as being within an authorised environment, or using the software inside an authorised time span or network system. In addition to conventional passwords, variants such as biological sensors (such as voice prints, iris or retinal patterns or fingerprints) may be used as is known in the relevant field, or methods achieving a similar purpose as may be developed or discovered in future.

CIPHER is the name for an encryption algorithm, using a key to encrypt plaintext or decrypt ciphertext (as herein defined)

CIPHERKEY is the name for a string of characters or other data sequence which are used by the cipher to encrypt plaintext or decrypt ciphertext.

CIPHERTEXT is encrypted information, made out of plaintext by use of the cipher, in conjunction with a given cipherkey.

CREATOR or OWNER refers to the person who originally created or at least encoded the workbook, or the party who has the rights to the workbook at the time of encoding.

DECODER or DECODER MODULE or PROGRAMME refers to the module or program which operates in conjunction with the independent software (as herein defined) to decode the secured dependent software (as herein defined), in order to facilitate normal operation of the secured dependent software.

DEPENDENT SOFTWARE is a widely distributed category of software that provides usually a particular service within an environment supplied by independent software (as herein defined). Examples include workbooks and worksheets for a spreadsheet program, database application software, macros and add-ins for common office applications, or script-type procedures associated with some programs, e.g. computer-aided design programs. Dependent material enhances or replaces functions of the independent software and may be written, edited, distributed, loaded, and executed by people who are users of the independent software. Further synonyms include “user-created content”, and “accessory”, “augmented”, “adjunct”, or “auxiliary” software; reflecting the inability of this software to function outside the environment of the independent software. This category is not limited to programming-type commands.

ENCODING or ENCODER MODULE or PROGRAM refers to the module or program which carries out the encoding process (as herein defined).

ENCODING or ENCODING PROCESS as used herein refers to a process of securing a dependent 55 software program (in whole or in part) or one or more specific data content items in order for it to operate correctly only when in conjunction with an authorised co-operative decoder programme (as herein defined). (This is distinct from encryption which is differentiated herein by describing it as a process for converting a string of characters from one form into another. However, “encoded” and “secured” are here used interchangeably to indicate protected content, e.g. secured dependent 60 software indicates that the dependent software has been encoded).

EXCEL is a registered trademark of the Microsoft Corporation of Seattle, Wash. and the term is used herein to refer to any version of that firm's spreadsheet application Excel—an example “independent software” application (as herein defined) originally written for the Macintosh and now used widely under the Microsoft Windows® environment.

HACKER A person who intentionally attempts to overcome the security protection placed about some software, or to discover the internal working of a software program.

INDEPENDENT SOFTWARE is a term used herein to refer to generic productivity software, such as databases, word processors, spreadsheets, presentation graphics packages, communications and e-mail software. The term also applies to some integrated packages such as CAD drawing software, mathematics and calculator packs and web browsers. The independent software provides a programming and working environment within which dependent software (as herein defined) may be created, edited, compiled or run. A particular example is Microsoft's “Excel”.

IP is an abbreviation for the commonly used and conventionally understood term “Intellectual Property”.

LOCATION SECURITY refers to a form of security wherein particular software will only operate within an authorised environment. Typically this is done within the accompanying software, such as by recognising an identifiable computer hardware environment, similar to the definition for “Authorised Environment” above.

PLAINTEXT is “normal” form text or string information, such as is typically readable and meaningful to a normal user.

PERSISTENT SECURITY is long-lasting protection which maintains confidentiality of the protected software (intellectual property) even after installation and during and after use.

SECURITY MODULE or PROGRAMME refers to the module or program that provides location security functionality by taking steps to verify the presence of one or more of: an authorised hardware environment, or an authorised user, or an authorised local area network (LAN) or the like.

SPREADSHEET: a program that allows any part of a rectangular array of positions or cells to be displayed on a computer screen, with the contents of any cell able to be specified either independently or in terms of the content of other cells, as is normally understood in the industry.

UNAUTHORISED ENVIRONMENT is used herein to refer to a place or computing environment where the authorised environment conditions (as herein defined) are not satisfied.

USER refers to the end-user of the dependent software (as herein defined)

WORKBOOK is a reference to a file comprising an entire “dependent software” package developed for incorporation into a spreadsheet and therein capable of implementing a desired function. It includes one or more modules or WORKSHEETS.

### BACKGROUND

Copying intellectual property like software in digital form has become fast, easy, accurate and cheap. Although copying has some fully legitimate purposes, illegal copying (piracy) is extremely widespread and in Europe is estimated to have cost USD 3.6 Bn in 1999. That value of the copied material reflects for example the many man-years of creative work usually included, and the competitive edge given to a possessor. Secure protection of software is justified for reasons such as to recover development costs, to protect a market position, to exercise a monopoly, or to avoid unauthorised modification (whether malicious or unintentional). Such modification could result in very expensive catastrophes or other detrimental outcomes.

A generic computer security system should offer outcomes including, but not limited to: confidentiality, authenticity, integrity, non-repudiation, security persistence, and ease of use.

Quality of software is an important issue because many users do not have the resources to verify results particularly with respect to third party software. In relation to one specific class of dependent software; workbooks developed by users for use in spreadsheets, a number of authors have noted abundant errors at a rate of over 25% of workbooks, or 3% of all cells in workbooks even including workbooks used by large companies in the course of their business activity. See for example publications by Panko, R. R. and others, cited in the website http://panko.cba.hawaii.edu/ssr/ which was available on the World Wide Web in 2004. It was suggested there that perhaps workbook creation is so easy that people ignore the usual software quality assurance methodology and development procedures, and use or distribute products including human errors at about the expected rate of occurrence for unverified productions.

Developers of dependent software would know that there is a lack of effective protection for their intellectual property. It may be that a range of professionally developed workbooks based on a culture of excellence, with software engineering, adequate testing, quality assurance and adequate documentation has hitherto been absent largely because of that lack of protection. There is not the money to cover this, in the absence of protection. One simple example of an expensive worksheet error having a casual origin is as follows. A column in a spreadsheet (not the displayed values, but the cells' actual contents) was rounded off to whole dollars. Unfortunately an inflation multiplier in the same column which should have been 1.06 was changed to 1.00. As a result a market was underestimated by US $36M.

This invention relates to the protection of dependent software which is otherwise relatively vulnerable to illicit copying. Most owners of independent software have more financial backing and more resources available to enforce their legal rights than do the owners of dependent software, as well as the opportunity to incorporate sophisticated protection schemes in the source code, which is not easily hacked in the compiled public binary executable. Dependent software may sometimes be compiled, but is most often distributed as plain text i.e. in a form that can be read Nand modified N by the average user. Simple password protection is available, but has been shown to be relatively weak, and hence usually ineffective. Even if distributed in an encrypted form, fall decryption by the user normally precedes use, when the dependent software again becomes fully vulnerable to reading, copying, piracy, or alteration, so the quality of persistence of security is lost. Software may fall into unintended hands by (for example) inadvertent distribution, interception of communications, industrial espionage, “cracking” of demonstration distribution software originally including limitations, use by contractors or during other out-sourcing of jobs, or removal by temporary employees, sub-contractors or employees about to leave or be fired. As a risk, disgruntled employees came second only to hackers in the 2003 CSI/FBI Crime and Security survey.

Microsoft's Excel is one example of independent software for which workbooks have been published for distribution. There are several well-known protection options for these workbooks, and at least as many well-known means for overcoming these techniques, including recovery of “lost” (or never known) passwords (for example the utility available at <www.lostpassword.com>). Protection can often be overcome simply by copying (using “copy all”) a protected Excel worksheet into a new blank worksheet. All is then revealed. At this time, several services offer to decrypt 40-bit (and stronger) encrypted material for a fee.

In another view, although an owner may be happy to distribute the dependent software at no cost, perhaps for promotion of another aspect of his business, and may have no cares concerning subsequent piracy, the owner and/or users may still require to be able to confirm the integrity of the code at a later date.

The following published examples are mentioned in order to indicate the present degree of development of protection. These examples should not be considered as an admission that the present application has previously been revealed.

Adobe Corporation's product “Acrobat Reader” includes means to attach persistent protection to PDF type documents (which are one form of dependent software). The security controls travel with the document at all times. An example control is the prevention of printing. However, such documents serve as an electronic equivalent of a printed hard copy, with visible contents, and are not normally capable of subsequent processing, in contrast to an Excel spreadsheet. The controls use attached digital signatures and may make use of public key/private key systems as exemplified by the RSA method (Adelman, Rivest and Shamir, U.S. Pat. No. 4,405,829). Ryan et al (WO01/59675) describes a peer-to-peer content sharing system in which workbooks for a spreadsheet are sent from a central location to a group of pre-specified users in order to collect information from each of them, and later reads the loaded workbooks into a master workbook in order to collate the information. Limited encryption is provided by means of name-value pairs or “key value pairs” as provided in Microsoft's Excel. The name-value pairs serve to manage each user's involvement and, through password protection of worksheets and the hidden worksheet facility, have the effect of limiting access by each user to certain areas (worksheets) only, while other worksheets remain invisible. Schlafly (U.S. Pat. No. 5,471,612) describes, for a worksheet formula, a method of compiling a formula into native machine language. Bauchot et al (U.S. Pat. No. 6,592,626) describes, for a worksheet, a method of converting standard cells into swappable cells which can be sealed off when in a safe mode in order to provide security—but only against inadvertent over-writing by the user while modifying the worksheet. This form of protection is weak; it refers only to integrity, and does not protect the worksheet from piracy. Waldau (application US 2003/0226105) applies some security to dependent software by compiling, in a modular manner, a workbook or worksheet developed under a spreadsheet into Java code, usable in a browser, hand-held computer or even in WAP-enabled cellular telephones.

Microsoft Corp has recently developed a scheme “Digital Rights Management” although it does not appear to address itself to providing persistent security protection on an item-by-item basis for dependent software; rather it tends to protect whole documents. After the priority date of this application, the inventor became aware of a software product called “Excelshield” originating from Praetorians of Zelezny in the Czech Republic. This product appears to have some similarities to the present invention. However the programme operates differently, does not have many of the features of the present invention, and runs much more slowly.

### OBJECT

It is an object of this invention to provide an improved software security functionality suitable for protection of the code of dependent software (as herein defined), or at least to provide the public with a useful choice.

### STATEMENT OF INVENTION

In a first broad aspect the invention furnishes a set of software programmes or software components providing means for secured use by a user of dependent software in conjunction with existing independent software within a digital computer, wherein the set of software programmes as distributed includes secured dependent software and a decoder programme; the dependent software having been encoded and thereby secured prior to distribution by an owner using an encoder programme which comprises a non-distributed part of the set; the dependent software is decoded by the decoder programme only on an as-needed basis during use, when in response to a call from the independent software the decoder programme decodes a restricted portion of the secured dependent software into a plaintext form for use by the existing independent software; said plaintext form having a transitory lifetime so that access by a person to the decoded portions of the secured dependent software is relatively infeasible, and so that although the user can use the secured dependent software, persistent security of the secured dependent software is maintained (including Intellectual Property security).

Preferably the set of software components as distributed also includes a security programme and the decoder programme is rendered incapable of decoding the dependent software unless the security programme has established the current presence of an authorised environment, so that the user cannot use the secured dependent software outside the authorised environment.

In a first related aspect, the invention provides a set of software components as previously described in this section, wherein the authorised environment is an approved software environment (one that includes at least one of: a specified version of software, an authenticated version of the independent software, a serial number, a digital certificate) so that in the absence of said at least one required conditions the decoder programme remains inactive and so that the owner of the dependent software may limit unauthorised use of the dependent software.

In a second related aspect, the invention provides that at least one cipher key is provided to an authorised user, so that the authorised user can provide the at least one cipher key to the decoder programme and allow deciphering and hence normal operation to proceed.

In a third related aspect, the acceptable cipherkey may be constructed during use from unique and persistent data associated with the secured dependent software so that a need for user input is obviated, thereby allowing relatively transparent operation of the secured dependent software.

In a fourth related aspect, the invention provides a set of software components as previously described in this section, wherein the authorised environment requires the presence of a currently authorised user; the conditions for being a currently authorised user are selected from a range including one or more of: receipt of payment for one-time use, approved window of time, acceptable total count of uses so far, presence of a pre-identified hardware environment within or about the second computer, entry of a personal identifier, entry of a non-transferable identifier, recognition of a biological attribute of a person; so that in the absence of said one or more required conditions the decoder programme remains inactive and so that an owner of the dependent software may limit unauthorised use of the dependent software.

In a fifth related aspect, the invention provides that the presence of an authorised environment is established by means of an exchange of recognised messages between the authorisation/security programme within the user's computer and a computer having a previously designated TCP-IP address within a network so that in the absence of said required exchange of messages the decoder programme remains inactive and so that an owner of the dependent software may limit unauthorised use of the dependent software.

In a sixth related aspect, the invention provides a set of software components as previously described in this section, wherein the authorised environment requirement for the presence of a pre-identified hardware environment within or about the user's computer is established by means of a location-sensing process capable of recognising the current presence of an approved hardware environment, so that in the absence of said required condition the decoder programme remains inactive and so that an owner of the dependent software may limit unauthorised use of the dependent software.

Optionally, the decoder programme may be made (by the owner at the time of encoding) to operate without having checked the one or more of the authorised environment security tests, so that although the dependent software may be copied and distributed by others (with the necessary decoder programme), secrecy of the encoded material is maintained and persistent IP security is thereby provided.

In a seventh related aspect, the invention provides a decoder programme package that is capable, on being called by the independent software, of providing the independent software with access to the secured dependent software by controlled decipherment of a specified ciphertext packet of information and return to the independent software of a plaintext packet of information compatible with use by the independent software.

In a second broad aspect, the invention provides a decoding security programme as previously described in this section, wherein the decoder programme package is capable, on being called by the independent software, of providing the independent software with access to the secured dependent software by a controlled decipherment of a specified ciphertext packet of information and return to the independent software of a plaintext packet of information in a form compatible with use by the independent software.

In a first related aspect, relevant in particular though without limitation to spreadsheet work, the invention provides a set of software components as previously described in this section, wherein the secured dependent software includes at least one secured portion selected from a range including: secured functions, secured computer-executable instructions including sets of instructions, secured formulae, and secured numerical values including constants; each secured portion, on being called by the independent software being passed to the decoding software in the form of at least one argument containing secured ciphertext to be decrypted by the decoding software and temporarily converted into a plaintext form capable of being used by the independent software; each element being a single packet of content.

In a second related aspect, the invention provides secured dependent software as previously described in this section, wherein the plaintext is provided to the independent software in one or more small portions, each of which has a transitory lifetime, so that the dependent software content is secure from discovery by any person so that persistence of security is maintained.

In a subsidiary aspect, if the or each small portion is decrypted by another person such as a hacker, it is likely that the small portions will be unsuited to being joined together, so that access to small portions will not materially compromise the integrity of the remaining secured content.

In a third related aspect, the invention provides secured dependent software as previously described in this section, wherein the or each small portion of decrypted content is held within a relatively secure memory or cache space and is more difficult of access by a person, so that persistence of security is maintained.

Optionally, the user is authorised to read at least some of the secured content of the dependent software, but is prevented from changing the at least some secured content. This authorisation may provided by the owner at the time of encoding only (via embedded permissions data) and is under strict software control. The user may have to enter a certain key sequence or an additional password in order to view the contents of a single cell.

Preferably the encoding programme and the decoding programme include an encipherment procedure with an effective encryption algorithm so that decipherment by hackers is rendered relatively infeasible.

As a first alternative, a single cipherkey is used for all copies of a workbook.

Alternatively a separate key is used for each released copy.

As a further alternative, a separate key is used for each purchasing organisation.

As a yet further alternative, multiple cipherkeys are used within a particular worksheet, or workbook, in order to render hacking or deliberate decryption even less feasible.

Alternatively the software packages of the invention incorporate obfuscation techniques in the software in order to thwart the attempt of hackers or other persons to carry out at least one task selected from the range of: reverse engineering the encryption code process; obtaining details of the dependent software; being able to deduce the cipherkey; nullifying the authorised environment verification procedures, or reverse engineering the decryption code process.

Optionally at least some of the small portions are supplied in an at least partially compiled or somewhat modified form, so that increased computational efficiency and/or speed and/or other benefits are provided as a result. For example this form could include exposed precedent references in the TESSPA( ) function call.

Alternatively the dependent software is decrypted in portions exceeding that of single packets of content within a relatively secure memory space, so that increased computational efficiency and/or speed is provided as a result.

In a third broad aspect, the invention provides independent software for use together with a set of software components together comprising secured dependent software and at least one software security programme for creating persistent protection of the dependent software characterised in that the independent software itself includes internal means for decoding of encoded dependent software in a restricted manner that reveals the content of the dependent software to the independent software but is secure from discovery by a user or any other person.

Optionally the independent software also includes programme means for verifying that an authorised environment is present, as previously described in this section.

In a related aspect the invention provides an add-in programme for use with a package of independent software for use together with a set of software components together comprising secured dependent software and at least one software security programme for creating persistent protection of the dependent software characterised in that the add-in programme includes internal means for decoding of encoded dependent software in a manner that reveals the content of the dependent software to the independent software but does not reveal the content to any person.

In a fourth broad aspect the invention provides secured workbooks for the independent spreadsheet software presently known as “Microsoft Excel”; wherein most encryption and decryption units are based upon user defined function (UDF) calls (herein referred to as “TESSPA( )” calls).

### PREFERRED EMBODIMENT

The description of the invention to be provided herein is given purely by way of example, as illustrating the concepts, or as illustrating some variations and refinements possible in regard to this invention and is not to be taken in any way as limiting the scope or extent of the invention. Although the illustrative example of “independent software” (as herein defined) described most fully herein is a secured workbook for a spreadsheet namely Microsoft's Excel as the independent software, the same concept may be applied to other independent software such as word processors such as (without limitation) Microsoft's Word, and may be used within many applications that support third-party routines (that is, dependent software) such as add-ins, macros, database handling, etc.

### DRAWINGS

FIG. 1: is a block diagram showing the creation of encrypted or secured dependent software and its subsequent use, according to the invention.

FIG. 2: illustrates a simplified digital computer in block form with reference to some identifiable hardware.

FIG. 3: as FIG. 3A(1), FIG. 3A(2), and FIG. 3B is screen capture images from a computer screen illustrating action of the encoder while being used to secure a workbook.

FIG. 4: as FIG. 4A and FIG. 4B is a screen capture image of a portion of an example secured worksheet (dependent software), as seen when in use within Microsoft's Excel (independent software).

This invention allows user-developed code, i.e. dependent software to be confidently distributed by writers or their agents without fear of loss of monopoly (through disclosure of contents or unauthorised duplication and use), because the secured content is kept confidential and proprietary at all times. The invention provides:
a) Intellectual Property Security, such that the intellectual property within the dependent software (or at least of the encoded portion thereof) is provided with strong security; and/or, optionally (but when required, just as strongly),
b) Location Security, such that the dependent software is prevented from operating outside the authorised environment (as herein defined).

This strong security is largely achieved by securely encrypting some or all of the user created dependent software or content prior to distribution), and providing decryption means to recover the plaintext content of the encrypted portions, usually on a line-by-line or analogous basis only at the time of use, (without which plaintext the independent software cannot operate correctly) and without allowing the user to see or otherwise discover the original plaintext content at any time. Decryption capability is provided by means of a decoder programme, which operates only subject to satisfying (owner selected) security module requirements, including authorised environment and/or user verification criteria.

### Example 1

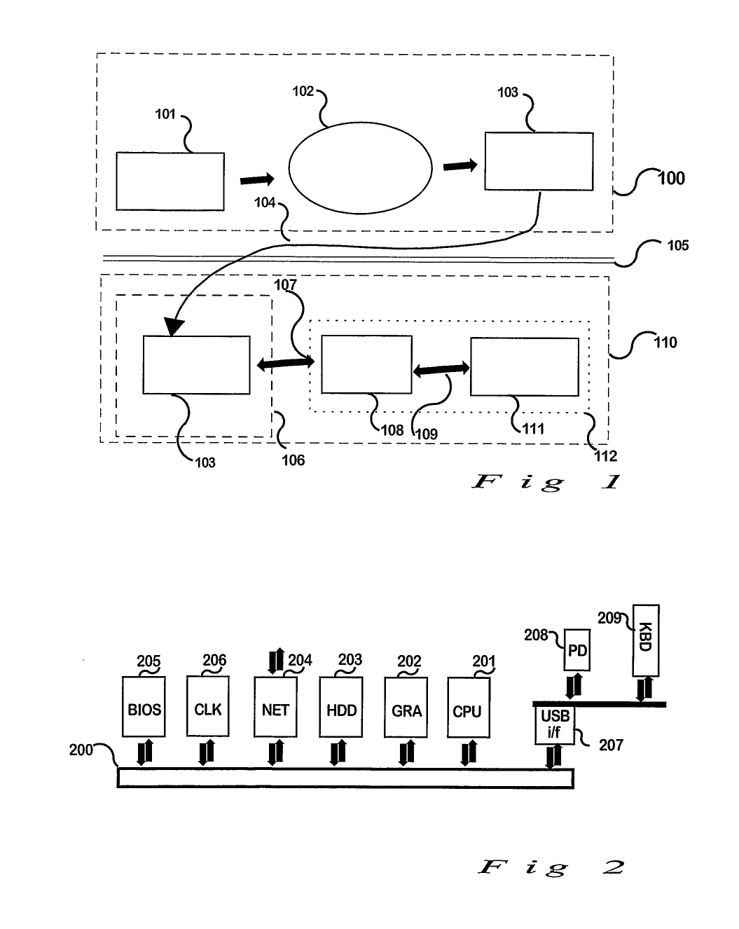

See the diagram in FIG. 1. Taking an Excel worksheet as a specific example of dependent software, let us assume that a workbook (101) has been written and has been assessed as being valuable. The owner(s) of that intellectual property wish to make it available though still under his(their) control to others—such as for use with others' data. The workbook has preferably been rendered substantially reliable and error-free before the encoding and encryption process of this invention begins. In FIG. 1, (100) represents one or more computers involved in the process of encoding dependent software. In the encoding process, an original worksheet (101) is presented to, and processed by, the special purpose encoder program (102), resulting in an encoded (or secured) worksheet (103) including embedded location security controls as required. This would normally be carried out in a secure area, for example behind a corporate firewall (105) and/or network or other security controls. After encoding, the owner of the software may distribute (104) the secured worksheet (103) such as to the public. (110) represents a user's computer that is running the secured worksheet (103), operating within the independent software environment (106) (for instance, it may be Microsoft Excel), in collaboration with the associated and user-transparent requisite decoder (108) and authorisation module (111), without which the encoded spreadsheet will not operate.

The first double-headed arrow (107) indicates the linkage between the encoded worksheet (103) and the decoder programme (108), with encrypted data packets being passed to, and plaintext data packets being returned from, the decoder programme (108). The second double-headed arrow (109) indicates bi-directional messages between the decoder programme and the authorisation module, which has confirmed that the user and/or the computer and/or the environment (110) are indeed authorised. These three (103, 108, 111) operate together as a coordinated functional unit, such that correct operation of the secured worksheet (103) requires and is wholly dependent on the presence and correct operation of the other two modules. (108) and (111) are typically transparent to the user. Optionally, the decoder programme may operate within and form part of the Excel software environment, while the authorisation module may be operated from behind a corporate firewall.

The invention provides a modified, secured form of dependent software (103) designed for use in association with independent software (106) (both as herein defined). When the secured, encoded dependent software according to the present invention is about to be run, a user's computing environment (110) software may include:
1. a running operating system (not shown) which is unaltered,
2. runnable independent software (106), also typically unaltered,
3. the dependent software (103), of which at least a portion has been secured (at 102) before distribution by means of encryption into a secure form (ciphertext),
4. a co-operative security programme or module (111) for checking that an authorised environment exists whether in terms of the user, the hardware, or availability over a local network of an identified response.
5. a decoder programme or module (108) for deciphering the dependent software using a cipherkey and having control means providing that packets (or groups of packets) will be made available as plaintext to the independent software, preferably in small portions and only during execution of the dependent software, and then re-securing or effectively discarding the plaintext packets immediately after use. Preferably these portions exist only briefly and preferably they are held in relatively inaccessible parts of a computer so that access by a person is rendered infeasible. It will be appreciated that the dependent software is not opened in an insecure form in toto before use and it is not present in an insecure form after use. The invention provides means for keeping the intellectual property secure so that it cannot be read or altered.
6. Additional means for checking proper authorisation (111) exist to confirm the presence of an authorised environment and/or an authorised user to the co-operative decoder programme 108; confirmation enabling action of the co-operative module and a lack of confirmation preventing action. This additional means primarily serves as an anti-piracy measure if needed. It will be clear to a reader that some developers of software may elect to ignore this aspect and hence block (111) is an option.
7. Optional means may be provided to encipher and/or otherwise obfuscate at least a portion of the displayed results at the time of closure of the dependent software by an authorised user, so that a subsequent unauthorised user or other person cannot discern what the authorised user had used under the dependent software, nor discern any meaningful resulting output. This may also be configured so as to be activated during use of the program as an added security measure.

The latter aspects provide that a possessor of the secured dependent software is never able to meaningfully view, copy (as plaintext) or modify the secured portion of the software. An entire file may be replicated and sent elsewhere, but its contents remain persistently secure and keep the standard security attributes: confidentiality, authenticity, integrity, non-repudiation, security persistence, and ease of use. The optional security environment test (6 above) prevents originals and replicas from being used if the specified confirmation is absent, thereby requiring would-be users to obtain by legitimate means a version having a specific cipher and/or authorised environment. Halting piracy means that there is or may be financial support for producing the dependent software at a higher standard, as well as the ability to distribute the software with reasonable confidence beyond a user base that previously would only have been acceptable to the originator. Security checks may comprise confirmation of a pre-approved hardware environment or other conditions as covered in the authorised environment (as herein defined). A following section headed “SECURITY ATTRIBUTES IN DETAIL” discusses this aspect. The last aspect (7) provides some protection against industrial espionage by hiding, after use, the input data and/or computed results that an authorised user had been using. This option may be enabled or disabled by an authorised user because there are many occasions when the dependent software should be preserved as an entity after running, and many others when the dependent software with user's additions should not be available to others after use. The authorised user can recover the encrypted data and reprocess it to obtain the subsequent results. This option depends on an ability to encrypt and/or obfuscate areas holding data packets and/or output results which are values as opposed to areas which are holding commands or other information supplied with the dependent software.

Different versions of the encoding program and the co-operative decoder programme (aspect 4 above) may be supplied for various situations in order to make a reliable interface to each of a range of independent software packages, including a variety of brands, a variety of versions, and a variety of operating systems within a variety of families of computer.

When secured dependent software is in use, the co-operative decoder programme, which may itself be enabled in some way as by a password or key for the purpose, is expected to work in synchrony with the independent software to:
1) Accept a specified (or a sequential) packet in ciphertext from the dependent software, provided by the engine of the independent software usually as a function call. (Unsecured commands are usually not contained within a function call to the secured co-operative decoder programme)
2) Taking the ciphertext within the function call then
   a) verify that the security flag (if used) indicates the presence of an acceptable environment (in relation to an authorised user, and/or to an authorised environment), and if true,
   b) decipher the packet into plaintext using an appropriate cipherkey, then
   c) preferably verify that decipherment was free of any errors, such as by comparison with a hash string added by the encoder programme to the ciphertext, then
   d) return the plaintext to the independent software for execution, if it is a command, or for another use, and
   e) preferably overwrite or otherwise hide the plaintext statement(s) as soon as possible after execution to minimise the potential for discovery by a hacker

Optionally the co-operative module is provided with further commands and/or data along with the primary enciphered material typically in a function call. For example, checksums or hash codes, and precedent lists (indicating pre-requisite processes or values) may be supplied.

Unless the co-operative module is provided with all necessary cipher key(s) and/or means to determine these so that it can carry out deciphering, enciphered parts of the dependent software will not be returned as plaintext and the program will not run correctly. Usually, the co-operative module is also enabled/activated following confirmation by the associated security testing procedure(s) that an authorised environment and/or authorised person exists.

A hacker could endeavour to bypass an external or separate security checking function for indicating that valid security is present such as by substituting a false confirmation. For that reason the co-operative decoder programme may optionally be combined together with the security module as one item. A secure/authenticated means of communication between these parts should be used.

Variations of the above outline, such as for use with other types of independent software (as herein defined) also come within the scope of the invention. Other variations include that the dependent software may be deciphered in its entirety very soon before execution of the beginiing, then stored in memory, and should be erased from memory immediately after execution is over. That option is potentially less secure because a hacker could halt execution by some subterfuge and potentially then recover the unprotected code from within memory. Preferably secured memory techniques such as encryption would be employed to mitigate this risk. Resulting benefits including processing efficiency and speed of execution may well justify the increased security risk as compared with the system based on the individual data packet function calls.

The dependent software could be compiled by a dedicated compiler, preferably in a manner immune from reverse compilation, and run without the independent software that spawned it. If the independent software comprehends pre-compiled functions, some or all of the executable elements distributed within the dependent software may be supplied in an at least partially compiled form rather than as source code. They may exist within the dependent software in pre-compiled form, or the deciphering package may supply pre-compiled code rather than plain English.

### Example 2

The following section provides details of the invention as an illustrative example within the Excel spreadsheet environment. The terminology used herein also assumes the Microsoft Windows operating system environment. Spreadsheets are widely used by many occupational groups. Millions of copies of Excel are said to be in use along with other spreadsheets including Lotus 1-2-3, Quattro Pro, and Star Office. Workbooks, which can be loaded into a running spreadsheet (serving as an independent software environment), and run, may have up to millions of cells within many coordinated worksheets. Each cell may contain for example (and without limit) one or more of: constants, strings, variables, formatting information or formulae, the result(s) sometimes being portrayed with quite sophisticated graphics. During execution, most formulae accept one or more values held in other cells which are identified to the formula, process those values according to specified and published rules, and display the results. A user would see a value in a cell after the resident formula had completed execution. For example a cell holding the simple formula “=C2*C3” would display the number 56 if C2 held 8 and C3 held 7. In a typical unprotected spreadsheet, a user can easily view and change any formula. Even in a protected spreadsheet employing the built in Excel protections (e.g. workbook, worksheet, macro & cell protection), the various utilities and services available on the internet for “unprotection” allow a user to relatively easily view and change any formula. Excel itself includes many convenient basic functions (such as SUM( ), SIN( ), AVERAGE( ), and RANDOM( )). With reference to Excel, user-defined functions of one or more lines may be written in Visual Basic for Applications (VBA) or an equivalent, and are usually named and treated as if they were formulae.

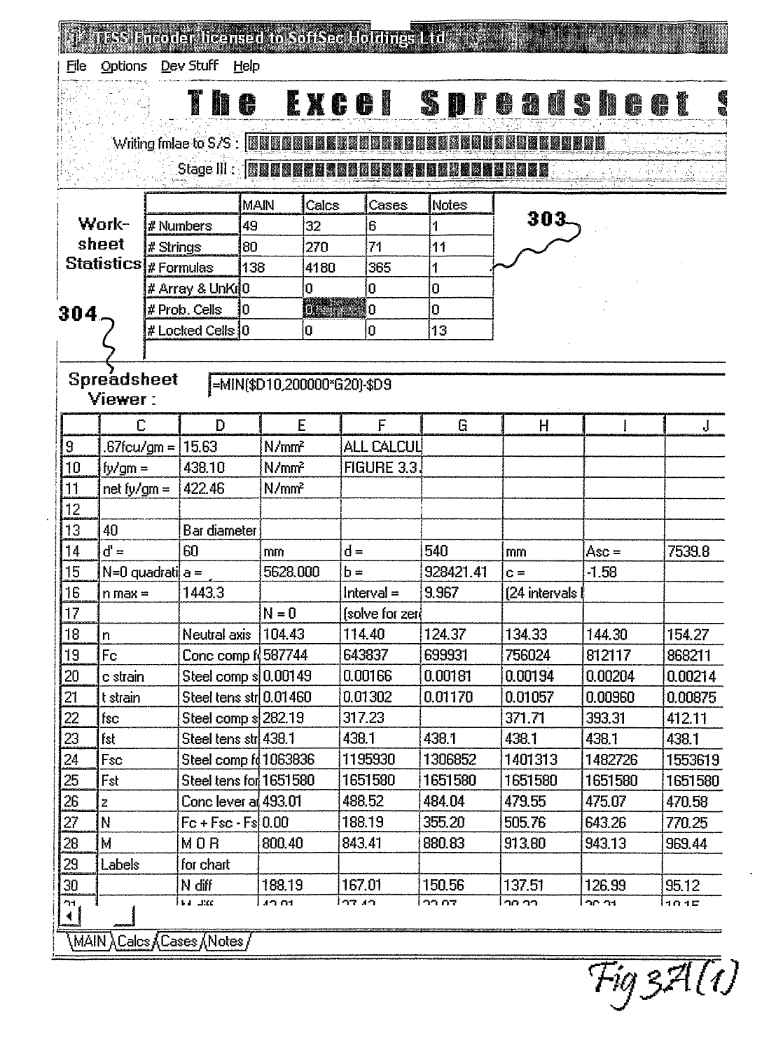

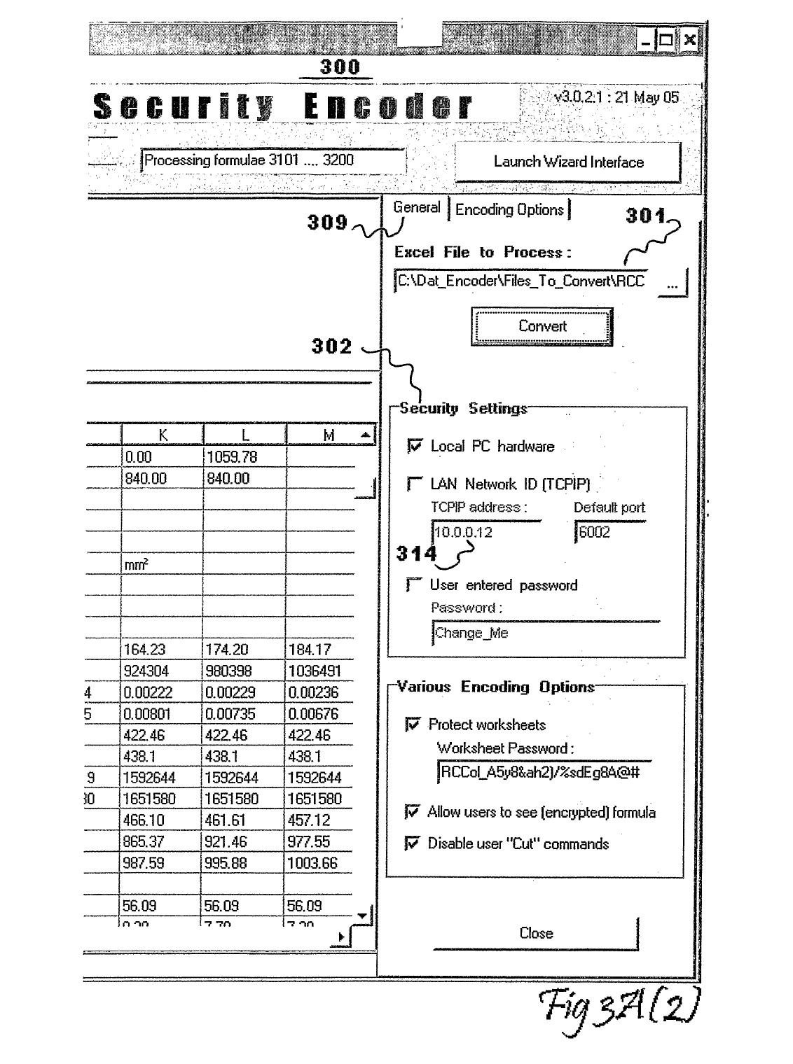

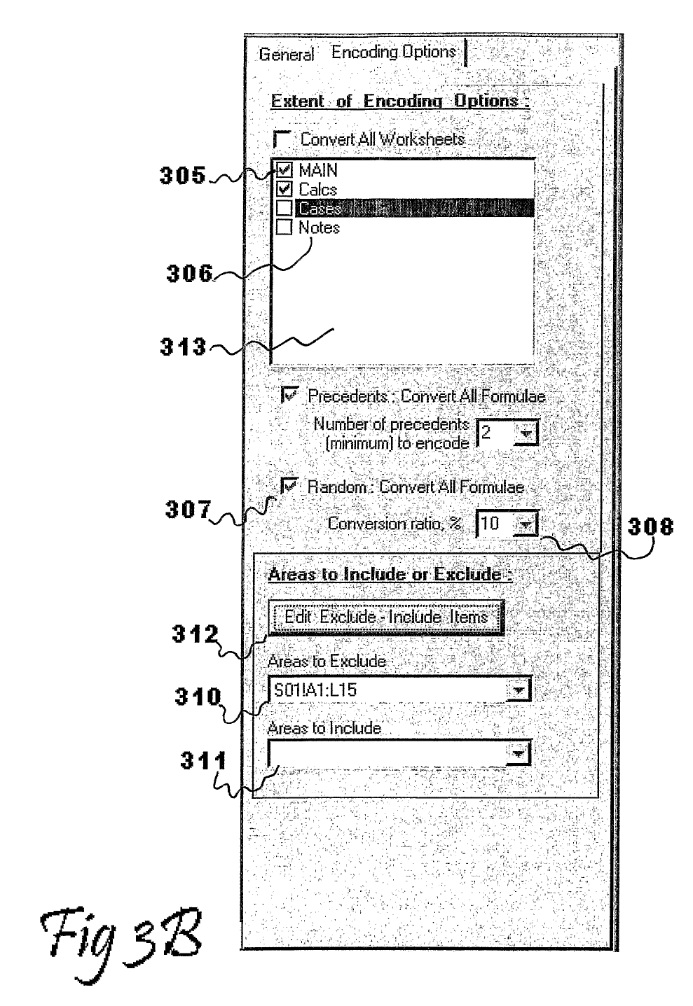

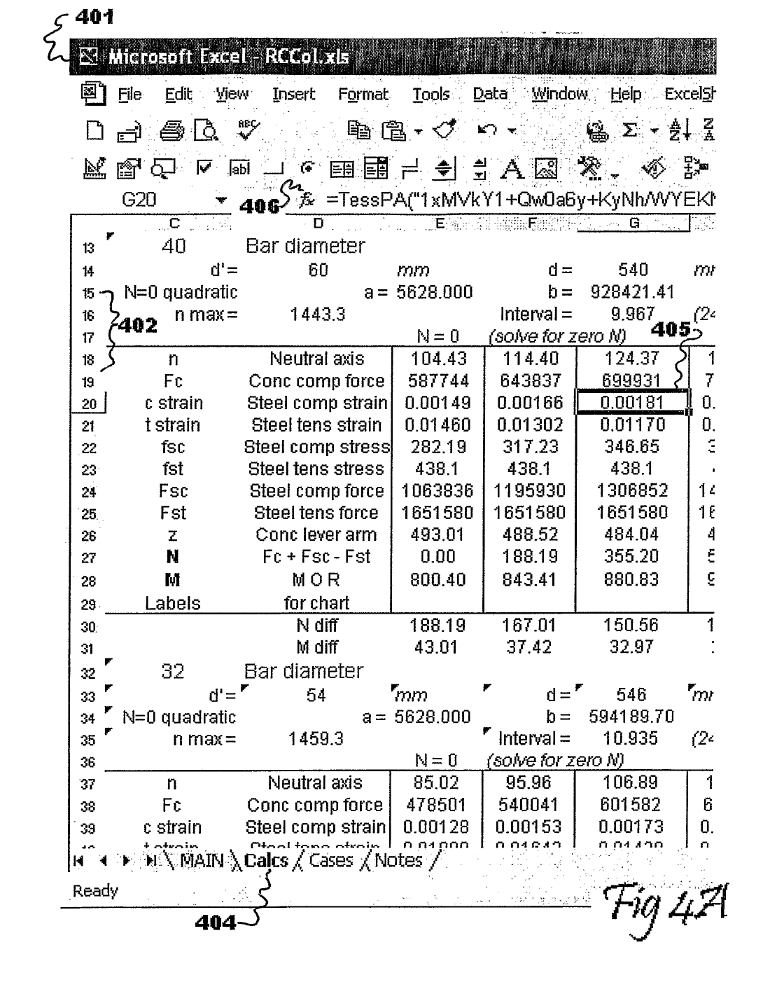

FIGS. 3 A and 3 B are screen capture images of an example security encoder screen, within the outermost window border (300). This example was written in “Delphi”. Here, FIG. 3 B shows just the display of “Encoding Options” selected when required at (309) as the alternative to the “General” and security options shown in the encoder screen at the right side of FIG. 3 A. The skilled reader will of course appreciate that many other screen layouts and combinations of underlying functions would be similarly suitable. FIGS. 3 A and B demonstrate a number of the available features. Encoding of a workbook to produce a secured dependent software package includes the following steps:
1) Loading and starting the encoder program (which has a general appearance as at (300))
2) Selection and loading into the encoder the file name of the workbook to be secured (filename and path shown truncated at (301)).
3) Setting various security options for the encoding process, as appropriate (302)
4) Preliminary analysis of the workbook, including calculation of statistics on the number of sheets, number of cells of various types (e.g. cells with formula, cells with numerical data, heading cells, cells with errors, etc).
5) Display of the preliminary analysis statistics (303), in conjunction with a representation of the original workbook or part thereof (Spreadsheet Viewer 304).
6) Display of user selectable options for the encoding process, including (without limitation):
   a) The worksheets, together forming the workbook, to be included or excluded in the encoding process (305, 306, in box 313)
   b) Selection of the authorisation mode(s) as in (302) are none, one, or more of the choices “Local PC Hardware, LAN Network ID, or User-entered Password; such additional parameters being entered or confirmed as necessary.
   c) Setting the overall percentage of cells to be secured (308) or simply, all cells (307)
   d) Identifying the cells or groups of cells to be specifically included in the encoded portion; these are entered on another screen accessed through button (312) and displayed in listbox (311)
   e) Identifying any cells or groups of cells to be specifically excluded from the encoded content; these are entered on another screen accessed through (312) and displayed in listbox (310).
7) Subsequent to any user input on options in 6) above, securing of the workbook then proceeds in an automated fashion (while displaying progress on the screen) in the following manner:
   a) Selection of a desired authorisation mode or modes within the box “Security Settings (302) such as none, one or more of “Local PC Hardware”, “LAN Network ID”, or “User-entered Password”. Additional passwords may be entered and confirmed as necessary.
   b) Scanning the complete workbook and creating a list of all cells to be secured
   c) For each cell to be secured (assuming a formula is present, for simplicity):
      i) (Optionally) Creating a list of the variables and precedents contained in the formula
      ii) Creating a hash (or checksum) of the original formula
      iii) Encrypting the concatenated formula and optional precedent list to create the ciphertext content
      iv) Concatenating the ciphertext and hash
         v) Returning a string of characters to the originator cell, in the form of a call including the ciphertext-hash arguments to the unique decoder function
   d) Repeating for all cells and worksheets to be encoded
8) Saving the workbook
9) Optionally, (but preferably) creating an installable package of the secured (dependent software) workbook, along with the decoder programme.

Many schemes are presently available for encipherment (also commonly known as encryption), as will be well known to those skilled in the relevant arts. Private key systems such as DES, Blowfish, Triple DES, Skipjack, AES, and the like may be used. Public/private key systems such as RSA, PGP, or the like may be used. Encipherment can be carried out using any suitable third party, publicly or commercially available software product, such as “LockBox” from TurboPower. Alternatively, a knowledgeable developer could create his own encryption and decryption routines. Preferred encryption procedures use robust and proven encryption algorithms of sufficient strength and sophistication to render decipherment by hackers relatively infeasible, given their current or anticipated level of skill and degree of assistance from computer hardware developments.

Normally, formatting instructions and the like will be left unsecured so that a user is able to vary those and it is reasonable to expect that a user's printing layouts for example will influence formatting.

As described above, the encoder program provides the workbook creator/owner with significant control over the extent of the encoded content within the workbook. One advantage of leaving some formulas unencoded is speed. Encoded content processing is considerably slower than for normal form content. For example a specific iterative sequence involving many passes but considered as having low IP value may be left as unsecured, i.e. in its ‘normal’ form (plaintext), although it may be a potential weakness in the security armour. Nevertheless, this is an option under the owners control. Any number of cells from one single cell of a workbook up to all cells may be encoded under the invention. Since the formulae of a workbook to be distributed are often the main protectable intellectual property of the workbook, in preference all formulae will be secured. However, the presence of some unsecured cells tends not to compromise the IP security of the secured cells. Furthermore, for a large or relatively complex spreadsheet, the presence of just a portion of secured cells should satisfy the location security aspect. In terms of IP security, many workbooks contain a proportion of ‘housekeeping’ and other mundane processing cells/areas, while the real intellectual property content is contained in just a small portion. In this situation, securing the latter while leaving the former unsecured will have little effect on the overall IP security.

The resulting encoded version of the dependent software (103) is now relatively secure and may be distributed in that form. A corresponding decoder module accompanies the dependent software, and optionally but usually, an authorisation module is also included.

A single cipherkey may be used for all copies of a workbook on the basis that (provided a strong encryption system is used) it is relatively infeasible for a hacker to crack the encryption system. In an additional, optional embodiment, a separate key for each released copy may be used, or alternatively one key for each purchasing organisation. Alternatively, multiple cipherkeys may be used within a particular worksheet, or workbook, in order to render hacking or deliberate decryption even less feasible. Cipherkeys may be created according to procedures well-known in the relevant art such as by using good random number generators, or by using one way hash type principles on some known original data, or other means.

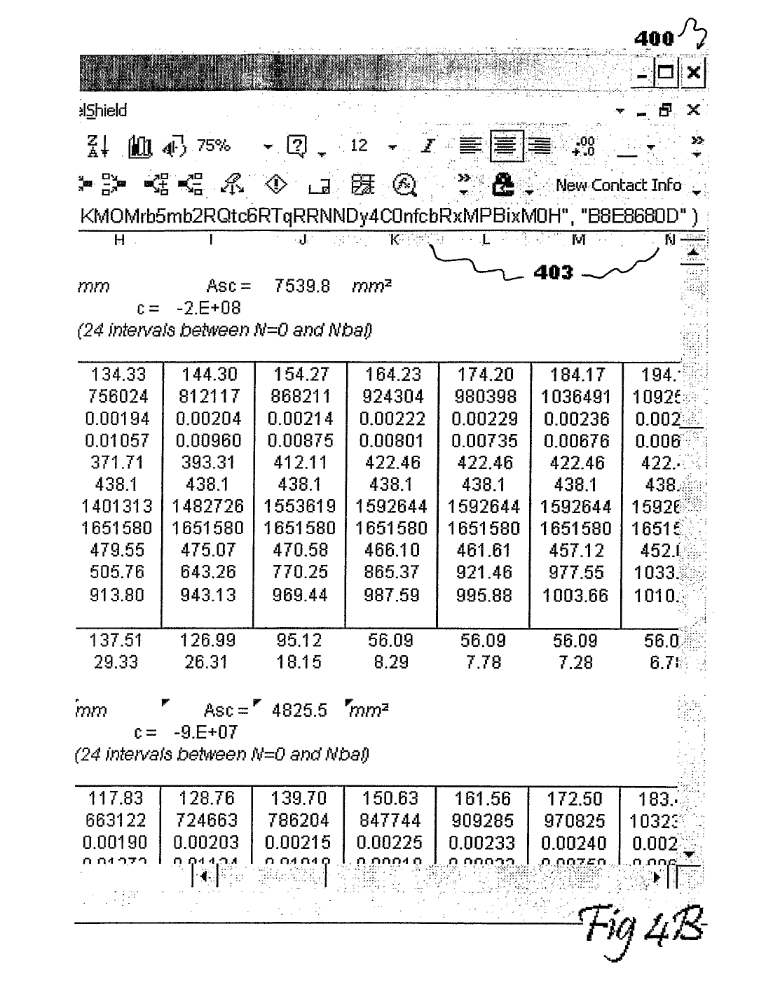

When a user loads the secured workbook under a normal copy of Excel (“normal copy” means that in this example no change to the independent software is expected) the usual screen layout (represented diagrammatically as (400) in an example application, FIG. 4, will appear with one or more visible worksheets in a workbook (404) available for view under the banner (401) of the independent software. As is customary, areas of a worksheet are set aside for various purposes. This worksheet is security-enabled. As usual for worksheets, areas are set aside for various purposes including input (left), processing (centre), and output areas (right). Results will appear overlaid upon cells in rows (402) and columns (403) that may contain formulae, whether those cells are enciphered or not, although outputs may be in graphic forms or otherwise moved about and arranged for presentation. The user's own data is imported into nominated cells in one or more of the usual ways such as imported files, keyboard entry, and the like. Note the currently highlighted cell G20 (405), displaying 0.00181. The enciphered code and a checksum from that cell are shown in encrypted form (“1xMVkY1 . . . ixMOH” “B8E8680D”) in the box (406) as a function (ƒx) which is a call to TESSPA. That, and the computed result in cell (405) (outlined by the cursor) is all of the cell that any user of this worksheet can view. The plaintext is concealed and protected.

The invention usually has no effect on data acquisition. Optionally, automatic recalculation is turned off until all cells are loaded. All cells, including those that hold data distributed in plaintext form will be visible as usual. Normal or plaintext formulae or the like held therein may be viewed normally. However, the plaintext formulae contained within the secured cells will not be visible or otherwise available in any way to a person, because of the obfuscation achieved by means of the encryption process. Cells holding enciphered information will show, if examined by a user (see cursor (405)), a novel function call having an enciphered string or strings of characters as at least one argument as at (406). The co-operative decoder module (held as software in (108) in FIG. 1), provided that the authorised environment security conditions are met, obtains from the ciphertext a plaintext character string, typically comprising the original formula. This plaintext formula is then used to obtain a result which is then put into or over the cell holding the still enciphered formula that has just been used.

Use of the plaintext formula to obtain a result may be achieved by one of several means, including:

a) by internally passing the plaintext formula to Excel for calculation, or
b) by calculating the result internally within the decoder programme, or
c) by passing the plaintext formula to some external routine for calculation, or
d) using some combination of the above

A user cannot feasibly discover the plaintext version of enciphered material inside a secured cell. The plaintext exists, probably within a memory cache or in a register in the CPU, for just about as long as the engine takes to parse and execute it, and will be overlaid by the next plaintext. The native Excel password protection system (which is relatively weak) is not being relied on at all. Strategies such as copying the worksheet cells into a new worksheet (as has been demonstrated to expose the previously hidden formulae) will not reveal the plaintext content of the enciphered material.

Excel handles user defined function (UDF) calls of the “TESSPA( )” type as illustrated in Table 1 below. Replicas of the dependent software can be copied amongst users along with the user data but the enciphered cells remain in that form. The invention retains the dependent software in an encrypted form having persistent security protection.

In more detail, Excel expects its formulas or procedures to be in one of the following forms:

(a) held (as plaintext) inside the cells of the workbook, or
(b) a call to an internal function, or
(c) an associated VBA (or similar) function, or
(d) a call to a function within an external file or module such as an add-in (whether of type .XLA type .XLL), or type DLL (or another file type as is appropriate for another spreadsheet or in response to future developments, as an expert reader will appreciate).

The invention provides a specific add-in module 108 as the co-operative decoder programme, presently in the form of a file of the type .XLL, (eXtensible Linking Language) but perhaps of a functional equivalent placed in a position where it is accessible to and usable by Excel. At the time of execution the appropriate cipherkey(s) are provided or obtained in order to decipher the previously enciphered worksheet information (in (103)) as required. Each formula or other command requiring deciphering before execution is held as an enciphered argument or arguments ready to be passed to a function herein (for example) called “TESSPA”; or another arbitrary, uncommon name. The Excel engine finds that function within the add-in module (108) and passes the enciphered material to the function for decryption and processing. The user is not aware of the action. Each secured formula is stored in the appropriate cell within the workbook, and each has an example format as shown in the example in the following table.

In an optional embodiment, the secured formula (or other content) may be stored in some location other than in the originating cell, for example in a binary or other form of data storage within the workbook, including on another page (worksheet), or in a binary or other form of data storage external to the workbook, but linked to the workbook. In both options above, the data storage means and the originating cell means should provide a unique link between the stored formula (or other content) and its originating cell.

TABLE 1

| name | Content |
|---|---|
| Original formula, i.e. | =K8+J9*((MOD(J9,2)*2)−1)/Div 1 |
| plaintext form | |
| General form | TESSPA(“<enciphered material>, <optional precedent list> |
| | <optional hash code>”) |
| As held, as visible, and | TESSPA(“7XW0B6DLmkG81mplCV+p/+Jd2bvX7+8/MIEIw371 |
| and as called. | ZqGTc64ffOejDXabwSa1roTGRnda+m0llo3eu4WmbMir0Q=F06 |
| | D3833”) |

Preferably a hash code created from the original plaintext is concatenated with the end of the enciphered string (as shown here) so that there can be a check subsequent to deciphering on the accuracy of the whole encryption/decryption security process, for example in order to detect whether a command was inaccurately stored or subsequently corrupted or modified. In an optional but preferable embodiment, the one-way hash code is used to ensure the deciphered plaintext formula exactly matches the original formulae, prior to calculation taking place.

The function TESSPA( ) calls the co-operative decoder programme which has the purpose of reversing the effect of the encoding program on a cell by cell basis, may test one or more security conditions as described elsewhere (see example 2a), typically verifies the accuracy of the plaintext formula by means of the one-way hash code, may detect a requirement for pre-evaluation of precedent formulae, and returns for use the plain-text, deciphered text string for processing as elaborated above. One version of a co-operative decoder is presented here in the standard form of pseudocode.

### Pseudo-Code for Co-Operative Decoder Programme:

// Global Constants & Variables
Constant var_Invalid_Result = Invalid_Value

| | |
|---|---|
| Dimension IsAuthorised_Environment as boolean | // initialised to false |

// Function to check whether the computing environment is ’authorised’, i.e. ’acceptable’
// ===============================================================
Function Check_Is_Authorised_Environment

| | |
|---|---|
| Test = Authenticate_Environment( ) | // This func examines the hardware etc to |

// ascertain acceptance (or otherwise) as
// an ‘authorised environment’

if Test = True
then IsAuthorised_Environment = True
else IsAuthorised_Environment = False

| | |
|---|---|
| End Function | // ---------------------------------------------------------------------------------------- |

// Function to decrypt formula and return a value
===============================================
Function TessPA( CText_Fmla )// Function call with CipherText_Formula argument

| | |
|---|---|
| Dimension All_Precs_Calculated as boolean | // Are all precedents calculated and valid ? |
| Dimension vFunc_Return as variant | // Function return value |

If( IsAuthorised_Environment = True )
then

| | |
|---|---|
| PText_Fmla = Decrypt( CText_Fmla ) | // Plaintext_Formula |
| Hash_Original = Extract_Hash( PText_Fmla ) | // Get stored original hash value |
| Hash_New = Construct_Hash( PText_Fmla ) | // Calc hash from the plaintext formula |
| if( Hash_New = Hash_Original ) | |
| then | |

| Precedent_List = Extract_Precedents ( PText_Fmla ) | |
|---|---|
| All_Precs_Calculated = True | // initialise to true |
| For each item in Precedent_List | |
| do | |

| If( IsCalculated ( Precedent_List[ Item ] ) ) | |
|---|---|
| then continue | // if OK, continue looping for rest of items |

| | |
|---|---|
| else All_Precs_Calculated = False | // not OK, set flag to show one or more |

//precedents are uncalculated

End for
If( All_Precs_Calculated = True )
then

vFunc_Return = Evaluate_Formula( PText_Fmla )

else

vFunc_Return = Uncalculated_Value

End if

End If

else

vFunc_Return = var_Invalid_Result
Display Error Message to User

end ;

Return = vFunc_Return

| | |
|---|---|
| End Function | // --------------------------------------------------------------------------------- |

There is some slowing of execution of the worksheet on account of the extra processing that occurs in relation to each step. Much spreadsheet processing is “single-pass” and speed is not likely to be an issue unless iteration of calculations occurs, or the workbook has complex formulae and/or is large.

All that the user has to do is

(a) load Excel (as usual),
(b) load the XLL file,
(c) load the secured dependent software (just as for a normal spreadsheet)
(d) enter a security key if requested (or otherwise satisfy the security requirements), then
(e) fill (or modify) the input data cells with user's data and record the results, as usual.

Often, automatic recalculation is turned off until all the data cells are filled. Preferably, the co-operative decoder programme is transparently installed on the users system at the time of installation of the secured workbook, thus obviating step (b) above, and enhancing the “ease-of-use” requirement of a good security system.

In one simple version of the invention, the presence of the add-in file comprising the co-operative decoder programme (108), along with a built-in cipherkey, is all that is needed in order to run the secured worksheet (103). It will be evident to an aware or skilled reader that a co-operative decoder programme, if intentionally disabled from testing one or more security conditions as described elsewhere could be distributed along with the secured dependent software. In that case the secured dependent software can be run, and copied to others, by anybody. Most of the usual aspects of security protection: confidentiality, authenticity, integrity, non-repudiation, and ease of use will remain in force, but because piracy of the pair may occur the developer does not have an easy opportunity to recover his costs from distribution of the workbook. Nevertheless, this option would be at the discretion of the creator/owner of the original workbook, i.e. not requiring location security enforcement flag(s) when encoding the spreadsheet. This simple version could suit many who simply want to ensure that their workbook—or at least the critical parts of it—remain protected from viewing—and/or from alteration, while not necessarily being concerned about location security or replication of the workbook.

An expert reader may suspect that one challenge associated with encrypting the formula as discussed in this invention is that this same encryption method effectively denies Excel the ability to ascertain the precedent-cell-dependent relationships. In other words, Excel is denied the opportunity to carry out optimisation of the calculation order to minimise calculation time. Processing is then necessarily carried out on a (fairly unintelligent) cell-by-cell order during calculation, and the TessPA( ) function typically needs to be made ‘volatile’. This volatile function property means calculation will eventually return to a cell (or any cells, call them “U”) which were earlier passed over due to one or more of the precedent cells being ‘uncalculated’, i.e. the values of that cell was not up-to-date according to the latest data set. Cell(s) ˜U″ will later be processed when it is intended that all precedents have been calculated and up-to-date, although this may require multiple iterations depending on spreadsheet complexity, structure, etc. Iteration continues until all cells have been calculated and verified as up-to-date. This volatility may result in slower total calculation times. In a further variation, the precedent list may be exposed to Excel (and hence be visible to the user also) while keeping the or each formula encrypted. While this will generally provide speed of execution benefits, the exposure of the formulae precedent information means that discovery of the original formulae is made more feasible by means of deduction. Nevertheless, this would in many cases be extremely time consuming and possibly unjustified from the hacker's perspective for all but the most valuable of spreadsheets. Exposure of the precedent list is easily achieved by means of a ‘parameter list’ series of plaintext precedent arguments following (or preceding) the encrypted formula argument(s). Again, providing this as an optional, user controlled, feature means that use of same can be restricted to situations where the benefits are the greatest and the detrimental potential security risk is deemed minimal (or acceptable) by the owner at the time of encoding.

### Verifying an Authorised Hardware Environment.

In order to control who can use the invention, the inventor has enhanced the invention by providing an optional anti-piracy security means. These ensure that it can be run only if an approved user, an approved environment, or both are present. A module of software (111 in FIG. 1) forming part of the set, herein called a “security module”, has the effect of either allowing (if the imposed conditions are satisfied) or inhibiting the co-operative decoder programme from deciphering and processing secured content. In that case it is likely that the person attempting to run the software would be shown a relevant error message, would see an erroneous value returned to the cell, an “#INVALID” type return value, or an equivalent. The decoder programme (108) will not operate correctly unless the security module (111) returns a permissive type of signal (which may be a bit set within a register or any other form of flag or signal as is well known to those skilled in the art). In case of a risk that the security module (111) could be substituted by a hacked version that sends out “OK” signals without doing any tests, one solution is to merge the co-operative and the security modules (108 and 111) into one. Another solution is to use a secured or authenticated form of communication between them.

One kind of preferred test carried out by the security module (111) is to determine the “location-specific” condition. In its checking for an authorised environment, the security module tests the hardware environment of the computer in which it is running. Many software languages include routines to ascertain these identifiers, or routines to do so can be written, using standard techniques. Unique identifiers are read from particular components of the computer and checked against a pre-loaded set of identifiers which had been created during an approval procedure in order to record and register to the security module the hardware environment of a specific, approved computer. See FIG. 2 which shows some components of a typical “personal computer” connected to a bus or backplane 200. Some hardware components (such as the CPU chip (201), hard disk (203), graphics card (202), particularly network interface cards (204) and the BIOS chip(s) 205) may include unique, accessible identifying numbers. There is less value in identifying portable items such as the pointing device or mouse (208) or the keyboard (209) which may not have unique accessible identification numbers, and/or may readily be swapped, and which may be connected through plugs to a USB interface (207). On the other hand a user can regard such a removable device as his or her personal key. In a “Citrix” type of network where most or all processing is carried out at a server rather than at terminals, or in one where unique identifiers are not available, alternative means may be used such as use of a dedicated circuit carrying a software-accessible unique identifying number in a chip within each terminal to be approved, or by using unique network specific identifier information. Providing that the dependent software with its supporting module(s) is being run within an authorised hardware environment, the user simply runs the workbook.

The security module may carry out a non-trivial conversion, one-way hash, or other protective operation on the unique numbers as obtained before reading the pre-loaded “key”, so that hackers cannot easily predict the pre-loaded key and substitute another that is appropriate for the actual computer being used.

### Verifying an Authorised User.

In an optional embodiment, a person may be accepted by the security module if the person can enter a key that is compatible with the enciphering process already carried out on the secured part of the workbook and/or satisfy some biological sensor criteria, e.g. retinal patterns, fingerprints etc, as covered in the “authorised user” term as herein defined. The key may be further qualified such as by time-of-day, by co-authorisation of hardware, or by other means. Identification of the user rather than, or as well as, the computer itself may involve passwords entered by keyboard 209 possibly in conjunction with time-of-day information read from clock 206 and possibly in conjunction with information obtained via the network card 204.

### Verifying Authorisation Over a Communications Link.

The security module may seek on-line approval over a communications link from a remote server, typically elsewhere in a LAN (local area network), a WAN (wide area network), the World-wide-Web, or other such existing or future communications medium. Authentication of a contact may again involve a password or detection of key elements of computer hardware bearing unique identity codes. The decoder module may use the network interface (204) to attempt to carry out an exchange of usually predetermined messages (which may be in ciphertext or plaintext) between the decoding module and a remote, secured, authorisation module within a server located at a pre-determined TCP-IP address. In FIG. 3A, (314) indicates an option within the Security Setting box (302) where the TCP-IP address may be entered. A result of failure to complete the message exchange is that the environment is deemed “unauthorised” and the decoder module is made inactive. With such options the owner or an agent for the dependent software may have an opportunity to monitor its usage, perhaps provide on-line support, and perhaps charge each user on a per-use basis, as well as a range of other real-time functions and opportunities. For example, a “back-office” authorisation database may provide real-time control (and monitoring) of access, by individual or personnel group, of spreadsheet classification or type, etc. Also, part of the activation key (or means to derive it) may also be stored in such a database, further enhancing the security aspect of the secured dependent software.

### Example 3

In a further optional enhancement there is the opportunity to protect an authorised user's data and results from other users who are not authorised, or even from authorised user(s) who have been assigned limited viewing and/or modification rights. This section refers to an additional process for encoding a value/number which had been visible in a cell, in a manner similar to the securing of formula content.

The optional means to make at least a portion of the secured workbook content protected, hidden, or otherwise not displaying the genuine values that were in use at the time of closure by an authorised user may be applied to any or all of: input data area(s), intermediate results area(s), and outputs results area(s). This option may be enabled or disabled at either run-time or the time of encoding, according to the encoding options selected by the creator/owner of the workbook. There are many occasions when the workbook results should be preserved after running, and many when it is desirable that the workbook activity and results should not be available to others after use. Authorised users can recover the encrypted data for example by loading the dependent software and re-calculating. Typically, this capability would be enabled by means of a public-private key system in conjunction with a user provided cipherkey, an on-line real-time authorisation capability similar to that covered in “VERIFYING AN AUTHORISED HARDWARE ENVIRONMENT” above, or similar. This option depends on an ability to secure and process cells holding values as opposed to, and in addition to, cells holding formulae or other information supplied with the workbook.

This functionality may be provided in a manner similar to the TessPA( ) function elaborated earlier, but with the additional capability of hiding or otherwise obfuscating the returned results when the workbook is being closed (or saved). In addition, this functionality may be automatically invoked when the (authorised) user is deemed not to have sufficient rights

Optionally, this functionality can be provided in several levels:
a) mandatory data hiding for all non-authorised users, or
b) owner control over whether data is hidden or not, or
c) providing restricted or full viewing and/or modification rights (even with an authorised environment) according to the authorised users' access rights. This would most likely be implemented in conjunction with a real-time authorisation capability.

One difference between encoded formula (i.e. programmatic content) and simple data content is that the latter may be made visible to an authorised user (or a select group of authorised users), while the former is never visible or accessible as plaintext to any user. The exception to this is if the program developer chooses to incorporate in the decoder program the ability to display one or more formulae to the user via (for example) a dialogue box. This is entirely possible. The decoder programme of necessity has the ability to retrieve the plaintext formulae, and it is programmatically trivial to display this to the user. This capability may “dilute” the IP security of the document. It should allow the spreadsheet owner/developer to have control over this feature. The feature may be made available to a restricted group of authorised users who could be required to enter some additional password/key information, and/or have some special access code(s) activated on their PC, and/or be a member of some special user group stored on the remote authorisation system database.

### Results Table

This table describes the overall outcome of various security scenarios, in conjunction with a secured dependent-software workbook. In the following scenarios, the assumed “approved user” is symbolic of a person who is authorised to use the secured workbook at their workplace in the course of the normal work, i.e. in an authorised environment. A “hacker” (defined elsewhere) is symbolic of a person who has by some means obtained (or attempted to obtain) a copy of a secured workbook.

The hacker is (typically, but not necessarily) a person who is not an authorised user, nor has access. Scenario 1. A workbook has been encoded with the option requiring security checking in regards to an authorised environment.

Scenario 1a: Approved user attempts to run the workbook in the normal workplace. Outcome They are able to successfully run the secured workbook, because the necessary co-operative decoder programme is active, the security module (being enabled) having found itself in an approved environment.

Scenario 1b: Approved (workplace) user duplicates a secured workbook, attempting to run it on their home PC. Outcome: attempt is unsuccessful because decoder programme was not also copied.

Scenario 1c: Approved (workplace) user duplicates a secured workbook and the decoder programme, attempting to run it on their home PC. Outcome: attempt is unsuccessful because the decoder programme call to the security module was not returned with an “OK” message, the security module not finding itself in a authorised environment.

Scenario 2. Hacker obtains a copy of a secured workbook and tries to open the workbook and read formulas (even outside Excel) and cannot do so because they are securely encrypted.

Scenario 3. Hacker obtains a copy of a secured workbook and tries to read formulas by some of the usual Excel means for overcoming password protection (such as copying into an unprotected worksheet) and cannot do so. The security remains in place because Excel is unable to cause decryption of the protected material.

Scenario 4. Hacker tries to run spreadsheet with the secured workbook, having also copied the co-operative decoder programme, in his own PC and cannot do so. The security remains in place because Excel is unable to cause decryption of the protected material. The necessary decoder programme is inhibited because it is in an unfamiliar, non-approved hardware environment.

Scenario 5. Hacker tries to make his own co-operative decoder programme (the XLL add-in file) but does not have the necessary decoding cipher nor the cipherkey that works with the secured workbook—so it does not work.

Scenario 6. Previously approved remote user (i.e. standalone PC using local hardware for authorised environment check(s)) tries to run secured spreadsheet, having subsequently changed some of the hardware on the PC, and cannot do so. The co-operative module is inhibited because when the authorised environment check is carried out it finds that the user's hardware environment does not match the previously approved configuration (example: CPU changed, or hard disk changed, etc). Solution, have the reconfigured computer re-approved.

Scenario 7. Hacker tries to run spreadsheet in a PC (such as laptop) which has been stolen from the office (after the hardware approval had already been set up).

Scenario 7a: The PC was part of an office network on which an authorisation module operated from the server. Outcome: secured workbook will not run due to the failure of the authorised environment check.

Scenario 7b: The PC was either standalone or part of an office network, but the authorised environment approved configuration relied solely on a user input cipherkey. Outcome: the thief (or subsequent would-be user) is not in possession of the cipherkey, thus the secured workbook will not operate correctly.

Scenario 7c: The PC was either standalone or part of an office network, but the authorised environment approved configuration relied purely on hardware components in the local PC. Outcome: the secured workbook will continue to operate correctly, but only on this stolen PC.

### Security Attributes—More Detail.

The persistent security feature provides a novel environment wherein (preferably) substantially error-free workbooks may be created and distributed and, if a workbook is later blamed by a customer for a loss, then owing to the property of persistent security the matter can be reliably investigated in order to establish where liability, if any, should be directed. Suppose that a workbook “W” has been created, tested as far as is feasible, rendered secure, and sold with a binding promise or guarantee of reliability. (The purchaser had to accept the promise at face value because he cannot discern the actual formulae that have been encrypted. He may, after purchase, choose to test the software under a variety of limit conditions against an alternative calculation machine), Then suppose a purchaser complains, or initiates legal action claiming that the workbook “W” had returned faulty results. There are other possibilities outside the formulaic content of the workbook itself, which include
a) the customer's data as entered was at fault;
b) the customer used an inappropriate workbook for the job;
c) the customer did not use “W” though he claims that he did;
d) the customer did not correctly use, or modified, the unsecured formulae in the workbook (if any)
e) the independent (parent) spreadsheet environment (e.g. Excel) was at fault;
f) one or more protected cells (i.e. secured formulae) within the copy of “W” had been altered, either inadvertently or maliciously; or
g) the output from “W” was incorrectly transcribed.

Because the persistent security property according to the invention is still in place, it is possible to retrieve the original distributed copy of “W” in question and run it either in a supervised environment, or within the customer's environment including his particular versions of software and hardware environment, using the customer's data, and comparing details with the developer's version of ˜W″ in order to verify which one or more of the above conditions, if any, may apply. The persistent security feature provides also that the originator can verify on a cell-by-cell basis that all the encrypted cells remain in the form as originally supplied by comparing the secured formula with the original the original distributed version, or recovering each one using the original key and inspecting the contents, so that “W” can be confirmed as authentic and that its integrity remains intact. Security also provides, by means of the non-repudiation property, that if “W” was at fault, the originator cannot deny responsibility.

This type of verification process permits errors, if any, to be correctly attributed. It allows, and may even cause, a vendor of protected workbooks to make a charge for professional quality software. The income would support an extensive process of testing, checking, and application of other types of quality assurance applied to the workbook before release, as well as preparation of adequate documentation intended to ensure that a user fully understands how to match the task to be carried out to the worksheet. The invention provides an environment in which good quality dependent software, particularly but not solely workbooks, can be made available for commercial use, using a commonly used office tool, e.g. Excel.

### Variations

Although the illustrative example of “independent software” (as herein defined) described most fully herein is a spreadsheet application, namely Excel, the same concept may be applied to other independent software applications that support third-party routines (that is, dependent software) such as add-ins, macros, database handling, etc.

For example, Microsoft's Word may be used with a wide range of add-ins such as (a) one to create Microsoft Reader e-books, (b) “Serenity Macros”; a whole suite of utilities, and (c) “EndNote Addin” (an example for maintaining a bibliography). Such add-ins may be written in any language which enables the creation of DLLs or XLLs or the like, such as VBA, and are inherently capable of accepting the encryption protection method of this invention.

Optionally, the cipherkey is constructed from certain aspects and/or unique and persistent data contained within (or associated with) the dependent software. This option obviates the need for (cipherkey) user input, allowing relatively transparent operation of the secured dependent software.

More than one callable function may be provided on the same occasion, and more than one argument may be used, of which at least one argument should be encrypted to provide the security aspect.

The owner of the software may permit some or all workbook formulas to be viewed under controlled conditions such as: only one formula, that in the cell under the cursor, can be seen at one time; and only if the authorised environment tests have confirmed that an authorised environment is present. This allows engineers, for example, to confirm the appropriateness of a given formula for a job. Such persons might reasonably not trust a workbook having only concealed formulas.

Excel offers a “Bigdata” binary data storage option that may be used as a means of storage of key encoding information or some or all the formulas or other secured content. An increased execution speed for dependent software is a benefit that must be weighed against possible loss of security. Other independent applications may include similar facilities, or analogous storage can be created by means of a separately written data file distributed along with the co-operative module. In that case the decoded material can be held, preferably under some form of encryption, and/or within a protected form of memory storage so that hackers find it relatively difficult to locate and read. The protected memory storage would need to be designed to minimise the chance of a hacker accessing the decrypted formulae (or content), and deducing the linkage between each formula and its originating cell.

Another possibility is for the software provided in encrypted form to include routines capable of replicating some functions of the independent software.

As an expert reader would appreciate, the system would be well suited to incorporation of a globally unique identifier (GUID) or other digital signature, uniquely and reliably being made a persistent and inseparable part of the secured software through inclusion in the activation key derivation process. This digital signature, and/or the remote authorisation process, may use virtually any type of system, including third party Digital Rights Management (DRM) systems currently being developed by Microsoft and others.

### INDUSTRIAL APPLICABILITY AND ADVANTAGES

1. The method provides persistent protection in an area of computer-related activity where reliable or strong protection was not previously available (dependent software, such as macros, workbooks and worksheets, add-ins, database handling, etc produced by third parties for existing application software (independent software)).
2. The method can be applied without making changes to the independent software itself, thereby retaining the original features and reliability (even any existing patches) of the application software. Notwithstanding, the fact that this invention has been discussed in terms of an unchanged independent software environment, the skilled reader will understand that changes to the independent software environment itself may facilitate and/or replicate the invention. Such change(s) will be recognised as being within the general scope and intent of this invention.
3. The method can be applied under a variety of operating systems and/or independent software versions.
4. The dependent software can be used under a “contents protected only” mode, wherein it can be run without restriction but not inspected or changed, or under a “execution restricted to approved circumstances” mode including raised protection against piracy in which there is a facility to control where the software can be run or who can run the software, i.e. location security, as herein defined.
5. The method has a low cost, and does not require co-distribution of uniquely identified hardware devices.
6. The method can be used on stand-alone computers as well as in networked systems.
7. The method assures an author that his work will not be changed so as to give an incorrect result.

Finally, it will be understood that the scope of this invention as described and/or illustrated herein is not limited to the specified embodiments. Those of skill will appreciate that various modifications, additions, known equivalents, and substitutions are possible without departing from the scope and spirit of the invention as set forth in the following claims.

1.-13. (canceled)

14. Secured dependent software adapted for use with independent spreadsheet software,
wherein the independent spreadsheet software comprises a means for producing a workbook comprising one or more worksheets;
wherein the one or more worksheets comprise one or more cells and are capable of holding functions, formulas, computer-executable instructions, sets of instructions, or constants; and
wherein the cells are also capable of holding a user's data or results; and
wherein the secured dependent software comprises:
a. a security means for preventing viewing of formulas, or use of the workbook by an unauthorised user;
wherein the security means comprises a non-distributed encoder module;
wherein the non-distributed encoder module converts the workbook into a secured form before distribution, thereby producing a secured workbook with secured content; and
wherein the secured workbook includes in situ replacement of plaintext contents of at least one selected cell of the secured dependent software into strongly encrypted ciphertext; and
b. a decoder module that is supplied with the workbook;
wherein the decoder module is capable, when in the use and only if all predetermined security conditions are satisfied, of co-operating with the independent spreadsheet software by:
1. detecting a call made by the independent spreadsheet software to an addressed cell within the secured workbook holding ciphertext;
2. acquiring, then decoding, the ciphertext and returning a plaintext version thereof to the independent spreadsheet software;
3. ensuring that the plaintext version is not made accessible to the user;
thereby providing security for the secured workbook in a persistent form such that it remains encrypted at all times; and
thereby keeping the secured content secret from the user, and preventing the user from viewing, altering, or copying the plaintext contents of the secured workbook.

15. The non-distributed encoder module according to claim 14,
wherein the non-distributed encoder module comprises software for converting the workbook into a secured form before distribution, thereby producing a secured workbook, by:
1. selecting at least one cell within the workbook for protection;
2. determining whether the at least one cell includes formula content;
3. performing in situ replacement of the plaintext contents of the at least one cell into strongly encrypted ciphertext;
4. establishing at least one cipherkey used for encryption and decryption of the workbook;
wherein each cell of the workbook is encrypted by at least one cipherkey; and
wherein discovery of the at least one cipherkey is duly concealed from the user; and
5. establishing security conditions for the workbook;
wherein the security conditions must by satisfied before the secured workbook can be used.

16. The non-distributed encoder module according to claim 15,
wherein a function of the non-distributed encoder module replace the plaintext contents of a selected cell by:
1. providing a function call which holds the plaintext contents as strongly encrypted ciphertext, in an in situ replacement; or
2. providing a unique in situ link;
wherein the in situ link provides a direct connection between the cell and a corresponding store of strongly encrypted contents; and
wherein the in situ link comprises a function call with direct linkage to ciphertext content either as part of, or directly linked to, the secured workbook.

17. A decoder module adapted for use with the secured dependent software according to claim 14,
wherein the decoder module includes an authorisation/location security means;
wherein the decoder module is capable, when in use and only if all predetermined security conditions are satisfied, of providing plaintext content obtained by decryption;
wherein the plaintext content is provided in a corresponding small portion after the one or more cells of the workbook have been addressed to the independent spreadsheet software; and
wherein each small portion comprises a transitory lifetime within a relatively secure memory or cache space, thereby effectively preventing access by the user.

18. The non-distributed encoder module according to claim 14,
wherein the non-distributed encoder module comprises software for providing the secured dependent software with information to put in place at least one security condition selected by the user; and
wherein the at least one security condition is selected from the group consisting of:
a. an acceptable user, acceptable computer hardware, acceptable network identification, acceptable window of time, and acceptable digital certificate; and
b. an acceptable receipt of a payment for use; and
wherein the plaintext contents are carried in encrypted form within, or directly associated with, the secured dependent software; and
wherein the at least one security condition must be satisfied before the decoder module is permitted to return the plaintext contents to the independent spreadsheet software;
thereby restricting the secured dependent software to being usable only in authorised environments and/or by authorised users; and
thereby keeping the plaintext contents carried in the workbook secret, and preventing viewing, altering, or copying by the user.

19. The non-distributed encoder module according to claim 14,
wherein the non-distributed encoder module is, when in use, capable of applying strong encryption to the plaintext contents held in at least one selected cell, but leaves precedent or precedents of the plaintext contents available in an unencrypted form, such that the independent spreadsheet software can scan the workbook, and determine a proper order of processing of the plaintext contents.

20. The non-distributed encoder module according to claim 14,
wherein the non-distributed encoder module comprises software which is capable, when in use, of:
a. encrypting the plaintext contents of any specified cell; and
b. including information in the workbook to permit the decoder module to display contents of any one specified cell as plaintext, but only when at least one previously specified security condition is present.

21. A decoder module adapted for use with the secured dependent software according to claim 14,
wherein the decoder module in combination with the independent spreadsheet software permits a user to select an operating mode selected from the group consisting of: manual mode calculations and automatic mode calculations; and
wherein Visual Basic Applications functions and routines are processed as if the user were using an original, unsecured workbook.

22. A decoder module adapted for use with the secured dependent software according to claim 14,
wherein the decoder module is capable, when in use, of obfuscating the results present in the workbook after authorised use, such that an unauthorised user is prevented from discovering the results.

23. A decoder module adapted for use with the secured dependent software according to claim 14,
wherein the decoder module employs unique and persistent data embedded in, or directly associated, with the secured dependent software to derive one or more acceptable decryption cipherkeys, such that need for user input is obviated;
thereby allowing relatively transparent operation of the secured dependent software.

24. Independent spreadsheet software capable of providing persistent security:
wherein the independent spreadsheet software includes an encoder module or a functional emulation thereof, which includes means capable, when in use, of allowing a user to determine one or more of the following:
a. which of one or more cells of a workbook are to become protected by means of strong encryption of the contents of the one or more cells;
b. details of one or more cipherkeys to be used for encryption and decryption,
c. extent of protection of the one or more cells; and
d. any associated security conditions that must be satisfied before a protected workbook can be used;
such that the independent spreadsheet software can be used to generated workbooks capable of distribution in a protected form.

25. The independent spreadsheet software according to claim 24,
wherein the independent spreadsheet software includes a decoder module or functional emulation thereof, which includes means capable, when in use, of processing a workbook previously protected by the independent spreadsheet software; and
wherein the workbook is processed:
a. in a manner retaining persistent security of protected cell or cells; and
b. on condition that all associated security conditions that have been specified must be satisfied before the workbook can be used;
such that the independent spreadsheet software can be used to generate workbooks capable of distribution in a protected form; and
such that the independent spreadsheet software provides enhanced functionality and security as compared to spreadsheet software that lacks capability of providing persistent security.
